(19) United States
(12) Patent Application Publication
(10) Pub. No.: US 2012/0170561 A1
(43) Pub. Date: Jul. 5, 2012

(54) WIRELESS COMMUNICATION SYSTEM AND RELATED METHOD THEREOF

(76) Inventors: Chih Hung TSAI, Kao Hsiung County (TW); Ya-Ying Wang, Taipei City (TW)

(21) Appl. No.: 13/340,340

(22) Filed: Dec. 29, 2011

(30) Foreign Application Priority Data
Dec. 30, 2010 (TW) 099146831

(51) Int. Cl. H04W 84/12

(52) U.S. Cl. 370/338

(57) ABSTRACT

A wireless communication system includes a first wireless apparatus, a second wireless, a profile determining apparatus and a priority determining apparatus. The first wireless apparatus transmits a first signal, and the second wireless apparatus transmits a second signal, where the first wireless apparatus and the second wireless apparatus conform to different communication standards, respectively. The profile determining apparatus couples the first wireless apparatus and generates a profile signal according to a profile of first wireless apparatus. The priority determining apparatus couples the first and the second wireless apparatuses, according to the profile applied to determine a transmission priority. Wherein, the wireless communication system bases on the transmission priority to determine the first wireless apparatus or the second wireless apparatus in a signal transfer coexistence mechanism to transfer signals.

### BACKGROUND OF THE INVENTION

(a) Field of the Invention

The invention relates to a wireless communication system, particularly to a coexisting system and method between a Bluetooth apparatus and a WLAN (Wireless LAN) apparatus.

(b) Description of the Related Art

According to all kinds of wireless communication products make an enhanced effect, so that techniques of Bluetooth and WLAN have good development respectively. However, both 802.11b/g/n and Bluetooth utilize 2.4 GHz band (belonging to ISM band, authorizing is unnecessary). Although there has different ways in modulation spread spectrum between Bluetooth and WLAN, the interference will affect transmission rates if the transmission ranges are overlap.

The present method for resolving the coexistence within the system of Bluetooth and WLAN includes: improving segregation degree for each antenna, adaptive frequency hopping of Bluetooth to shield off the operating band of WLAN, and utilizing coexistence signals between Bluetooth and WLAN to transmission by time division . . . etc. Wherein, time-division is an approach, which informs the packet transmission priority of Bluetooth and WLAN and transmission type to packet traffic arbitration (PTA) according to coexistence signals. Accordingly, PTA determines which packet can be transmitted according to the transmission priority from the packet-by-packet base method.

However, packet-by-packet base will have many problems when Bluetooth transfers some specific profiles. For example, a local Bluetooth connects with a far Bluetooth by using headphones to proceed voice transmission. Therefore, the packet of voice transmission have high priority and high density (normal interval is 3.125 ms). If through the way of packet-by-packet base, when WLAN transmits a packet over 3.125 ms (ex. 802.11n mode aggregation packet or 802.11b DSSS 1M & 2M), the packet will be deferred because the packet has lower priority. There may be not enough time to transfer present packet, and then present packet will be interrupted by the next voice packet of Bluetooth. Finally, WLAN will be disconnected because the present packet has transmission failure. Furthermore, Bluetooth transfers file to a cell phone through File Transfer Protocol (FTP), the packet of FTP will be classified to low priority. At this moment, if the packet transmission priority of WLAN is higher than Bluetooth, packet of FTP does not have opportunity to be transferred.

Therefore, how to keep a good transmission rate that WLAN and Bluetooth can transfer and receive simultaneously is very important.

### BRIEF SUMMARY OF THE INVENTION

One object of the invention is to provide a profile, which has better coexistent efficiency according to a wireless apparatus.

Therefore, the profile is referenced by the connection device form Bluetooth, it will have better coexistent efficiency.

However, according to Bluetooth protocol, the profile is belonged to upper layer protocol, but Bluetooth controller belonged to lower layer protocol cannot receive any information directly. Therefore, the present invention further provides a method that WLAN and Bluetooth belonging to lower layer can get the information which Bluetooth is proceeding with.

One embodiment of the invention provides a wireless communication system, comprising: a first wireless apparatus for transferring a first signal; a second wireless apparatus for transferring a second signal; and a priority determining apparatus for determining a transmission priority of the first wireless apparatus and the second wireless apparatus, which is under a coexistence mechanism and according to a profile of the first wireless apparatus; wherein, the first wireless apparatus and the second wireless apparatus conform to different communication standards separately.

One embodiment of the invention provides a sharing method of a first wireless apparatus and a second wireless apparatus, the first wireless apparatus is to transmit a first signal, the second wireless apparatus is to transmit a second signal, the first and the second wireless apparatuses have different communication specifications, the method comprises: determining a priority of the first wireless apparatus and the second wireless apparatus, which is under a coexistence mechanism and according to a profile of the first wireless apparatus.

### BRIEF DESCRIPTION OF THE DRAWINGS

FIG. 1 shows a schematic diagram illustrating a wireless communication system according to one embodiment of the invention.

FIG. 2A shows a contrast table illustrating wireless communication system according to one embodiment of the invention.

FIG. 2B shows a schematic diagram illustrating a contrast table of a wireless communication system according to one embodiment of the invention.

FIG. 3 shows a schematic diagram illustrating a control interface signal format of a wireless communication system.

FIG. 4 shows a schematic diagram illustrating a coexistence signal of a wireless communication system.

FIG. 5 shows a schematic diagram illustrating a wireless communication system according to one embodiment of the invention.

FIG. 6 shows a schematic diagram illustrating a wireless communication system according to one embodiment of the invention.

FIG. 7 shows a schematic diagram illustrating a wireless communication system according to one embodiment of the invention.

FIG. 8 shows a schematic diagram illustrating a coexistence signal according to one embodiment of the invention.

FIG. 9 shows a look-up table illustrating a wireless communication system according to one embodiment of the invention.

FIGS. 10A, 10B, and 10C show a flow chart illustrating an operating example of the method, which uses a plurality of wireless apparatuses simultaneously.

### DETAILED DESCRIPTION OF THE INVENTION

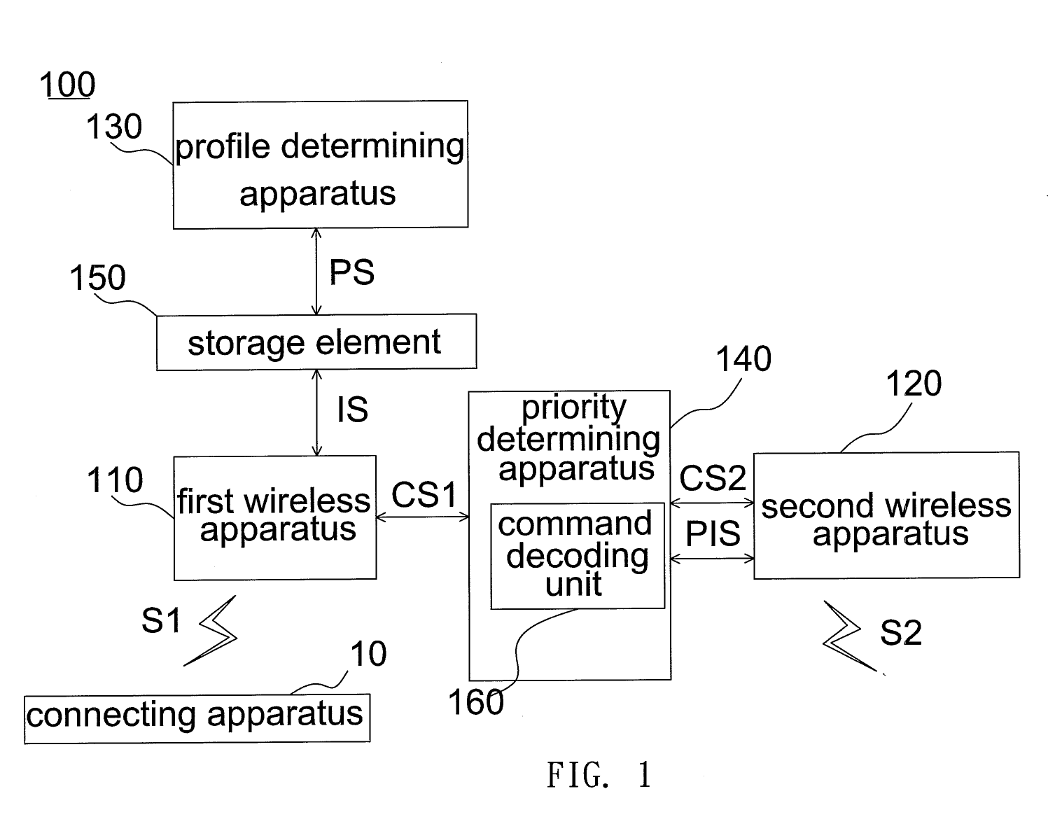

FIG. 1 shows a schematic diagram illustrating a wireless communication system 100 according to one embodiment of the invention. Wireless communication system 100 comprises (but it should not be limited) a first wireless apparatus 110, a second wireless apparatus 120, a profile determining apparatus 130, and a priority determining apparatus 140.

Wherein, first wireless signal S1 is generated and transmits by first wireless apparatus 110; second wireless signal S2 is generated and transmits by second wireless apparatus 120. Furthermore, first wireless apparatus 110 and second wireless apparatus 120 conform to different communication standards separately. For example, in one embodiment of the present invention, first wireless apparatus 110 is Bluetooth apparatus, and second wireless apparatus 120 is WLAN apparatus.

As shown in FIG. 1, priority determining apparatus 140 couples to first wireless apparatus 110 and second wireless apparatus 120. First wireless apparatus 110 transmits a coexistence signal CS1 to priority determining apparatus 140, second wireless apparatus 120 transmits a coexistence signal CS2 to priority determining apparatus 140. Priority determining apparatus 140 determines priority of transmission according to coexistence signals CS1 and CS2 of first wireless apparatus 110 and second wireless apparatus 120, so that wireless communication system 100 can transfer signal under a coexistence mechanism. In the present embodiment, the coexistence mechanism is a time-division mechanism. In other words, when first wireless apparatus 110 or second wireless apparatus 120 transfers the packet, the packet density can be adjusted according to the transmission priority or the profile.

It should be noted that, the coexistence mechanism is a time-division mechanism, it should not be limited in the invention. Besides, the coexistence mechanism can be implemented by any current or future coexistence mechanism, for example: frequency-division.

Profile determining apparatus 130 couples to first wireless apparatus 110 and generates a profile signal PS by a present profile of first wireless apparatus 110. Wireless communication system 100 comprises storage element 150. Storage element 150 is to store a communication protocol or driver, and couple to profile determining apparatus 130 and first wireless apparatus 110. In present embodiment, the communication protocol stored by storage element 150 can be Bluetooth core stack. Storage element 150 receives profile signal PS, and generates a control interface signal IS to first wireless apparatus 110 by profile signal PS and the communication protocol.

When profile determining apparatus 130 adds or changes the action, storage element 150 generates the control interface signal IS to first wireless apparatus 110 according to profile signal PS.

In other words, upper profile determining apparatus 130 with storage element 150 can generates suitable control interface signal IS to control first wireless apparatus 110. Wherein, in the embodiment, control interface signal IS is standard host controller interface command. For example, profile determining apparatus 130 can determine profile according to a purpose of connecting apparatus 10, or connecting apparatus 10 which the first wireless apparatus is connected to, so that profile determining apparatus 130 with Bluetooth core stack stored in storage element 150, generates corresponding control interface signal IS to control first wireless apparatus 110.

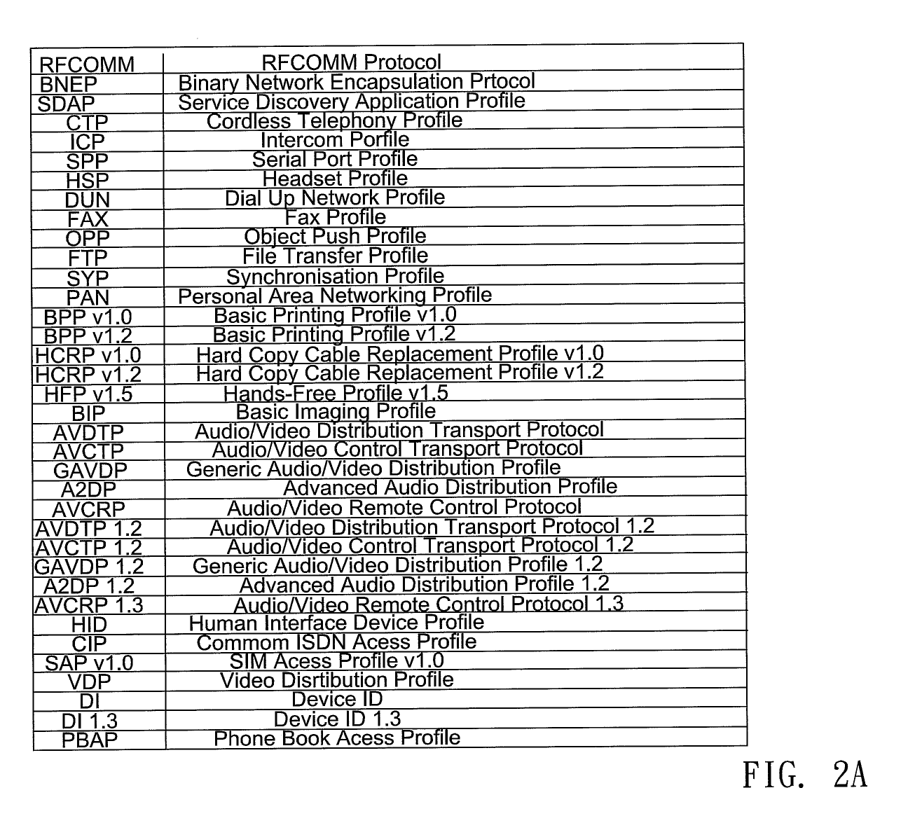

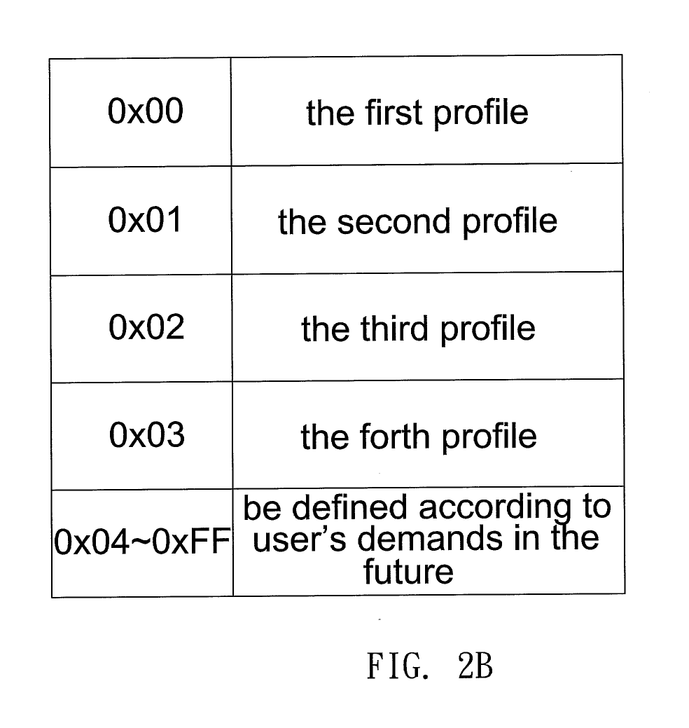

It should be noted that, in one embodiment, profile determining apparatus 130 has a contrast table to store a plurality of profiles. As shown in FIG. 2A, FIG. 2A shows a contrast table illustrating wireless communication system according to one embodiment of the invention. In the embodiment, it has a total of thirty-six profiles. For example, profile A2DP belongs to advanced audio distribution profile. To be noted that, the contrast table should not be limited in the invention, the contrast table can be implemented by any current or future contrast table, for example: the profile is determined by the apparatus 10 which first wireless apparatus 110 is connected to.

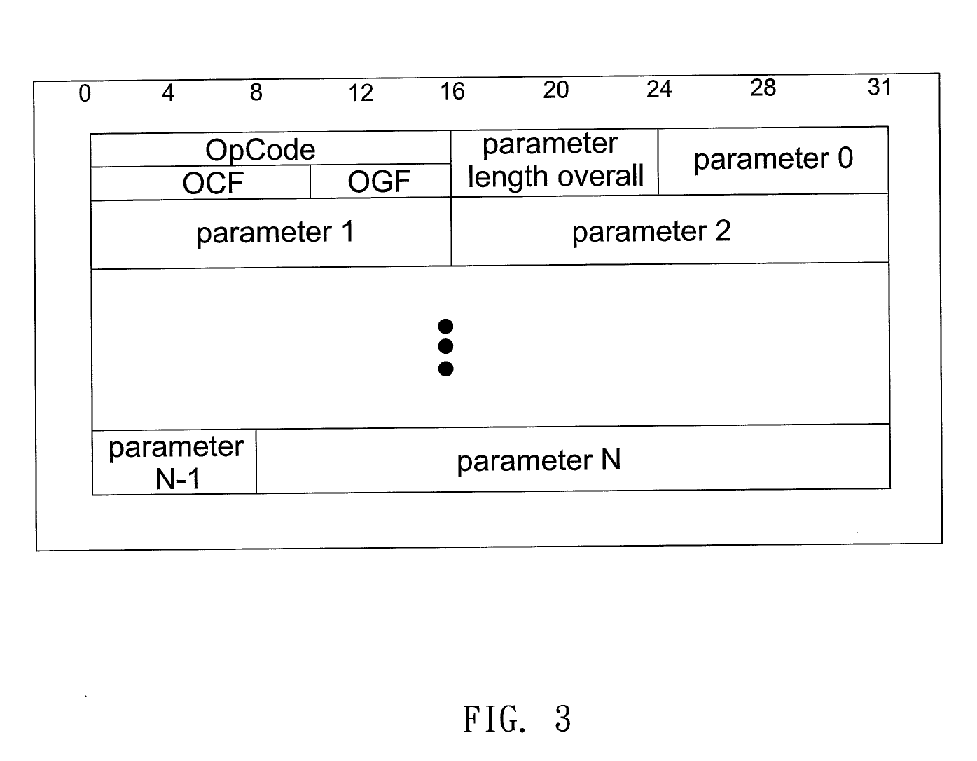

Please refer to FIG. 3, FIG. 3 shows a schematic diagram illustrating a control interface signal IS format of the present invention. Wherein, if op code group field (OGF) of Op Code is equal to 0x3f, OGF belongs to vender-specific debug commands and is to transfer standard non-Bluetooth commands to first wireless apparatus 110. Aforementioned Op Code is only an example, the present invention can also utilize other standard non-Bluetooth commands as control interface signal IS.

Therefore, in the embodiment, parameters of control interface signal IS, with a way of 32-bit bit map, is to indicate that what types of the profiles. When the profile which first wireless apparatus 110 is executing changed, profile determining apparatus 130 generates profile signal PS to storage element 150, then communication protocol stored at storage element 150 sets parameters, changing the bit map, of control interface signal IS to first wireless apparatus 110.

For example, when first wireless apparatus 110 (in present embodiment is Bluetooth) connects with a Bluetooth headphone and utilizes profile A2DP of the contrast table (as shown in FIG. 2A), in one embodiment, communication protocol will set parameters of control interface signal IS to 0x00400000 because profile A2DP is the 23th in the contrast table. Communication protocol will inform present state to first wireless apparatus 110 via control interface signal IS, then first wireless apparatus 110 generates coexistence signal CS1, which is corresponding to present state.

Then, priority determining apparatus 140 determines or adjusts transmission priority according to coexistence signals CS1 and CS2 which is from first wireless apparatus 110 and second wireless apparatus 120.

When the Bluetooth headphone had finished hearing, profile A2DP is removed. Communication protocol will restore parameter control interface signal IS to 0x0, inform to first wireless apparatus 110 via control interface signal IS.

Please refer to FIG. 2B, FIG. 2B shows a schematic diagram illustrating another contrast table of a wireless communication system according to one embodiment. The contrast table has four simplified profiles, for example, the first profile is when parameter of control interface signal IS is 0x00(ex: first wireless apparatus 110 is transferring via FTP); the second profile is when parameter of control interface signal IS is 0x01(ex: first wireless apparatus 110 is connecting with Bluetooth mouse); the third profile is when parameter of control interface signal IS is 0x02; the forth profile is when parameter of control interface signal IS is 0x03(ex: first wireless apparatus 110 is receiving music by using Bluetooth headphone). Therefore, the parameters included by control interface signal IS, which can utilizes 16 bits of bit map to indicate what type of profile is, and then parameters 0x04˜0xFF can be defined according to user's demands in the future. In the embodiment, because of first wireless apparatus 110 is connecting with Bluetooth mouse, priority determining apparatus 140 will determine that the second profile has higher priority to avoid the Bluetooth mouse deadlocking and inconvenience when user is using it.

In the embodiment, control interface signal IS includes profile signal PS, and control interface signal IS adjust the transmission priority of first wireless apparatus 110 according to profile.

When first wireless apparatus 110 get the information of the profile executing has been changed from the receiving control interface signal IS, in one embodiment, first wireless apparatus 110 utilizes an I-Square C form to inform second wireless apparatus 110 according to coexistence signal CS1. The I-Square C signal can be satisfied by extra general purpose I/O (GPIO).

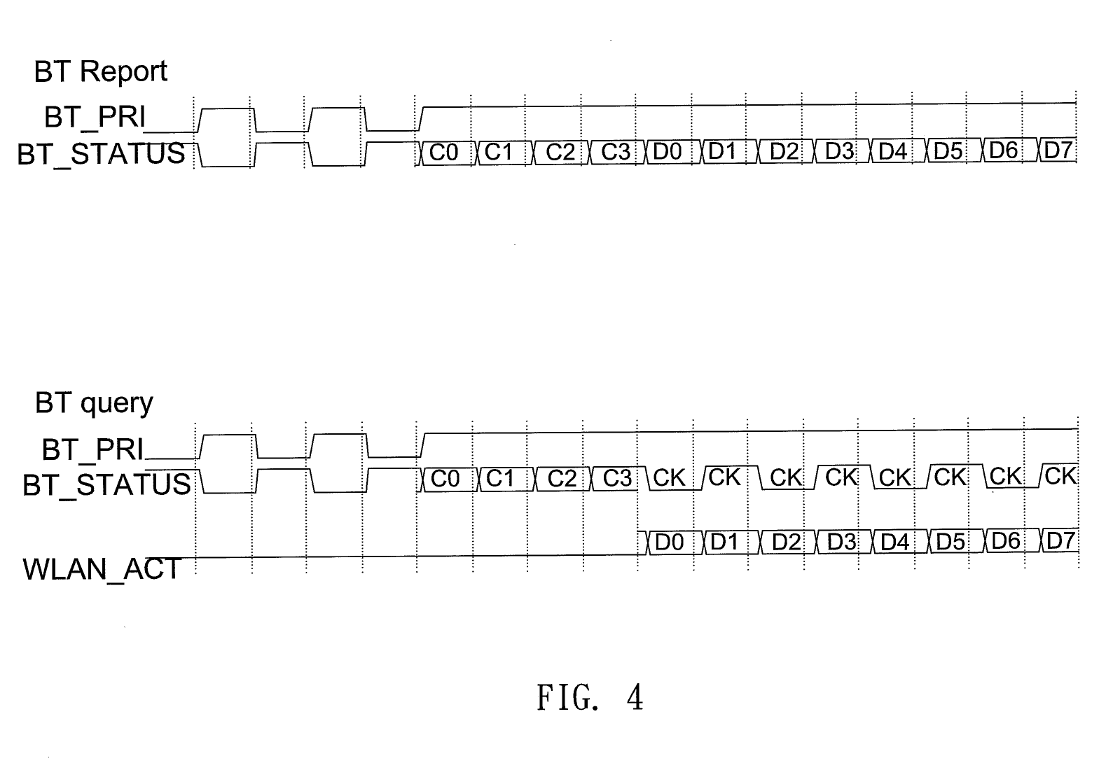

In one embodiment, please refer to FIG. 4, FIG. 4 shows a schematic diagram illustrating a coexistence signal of the wireless communication system. First wireless apparatus 110 utilizes BT_PRI and BT_STATUS of coexistence signal CS1 to transfer the profile. At the beginning, first wireless apparatus 110 utilizes four continuous time slot signals, to inform second wireless apparatus that the coexistence signals CS1 and CS2 are temporarily switching into message transmission mode. Then, C0˜C3 represent types of commands; D0˜D7 represent contents of signal transductions. By this method, the profile can be transferred to priority determining apparatus 140 through suitable format of C0˜C3 and D0˜D7, is to be command decoding.

In other words, priority determining apparatus 140 determines whether the profile of first wireless apparatus 110 is changed or not in every predetermined time period, which is through signal transmitting of BT query, BT Report, and WLAN_ACT shown in FIG. 4, so that second wireless apparatus 120 can adjust correspondingly. In one embodiment, priority determining apparatus 140 can also determine that first wireless apparatus 110 operates in which frequency band via the same method, to make second wireless apparatus 120 adjusting correspondingly.

It should be noted that, in the embodiment, priority determining apparatus 140 includes a command decoding unit 160. Which is to decode profile signal PS of coexistence signal CS1 that transfers from first wireless apparatus 110; then, priority determining apparatus 140 transfers profile indicating signal PIS to second wireless apparatus 120. When priority determining apparatus 140 is informed the profile changed, priority determining apparatus 140 can report the information to the driver or firmware of second wireless apparatus 120 so as to select corresponding coexistence mechanism according to the different attributes of profiles.

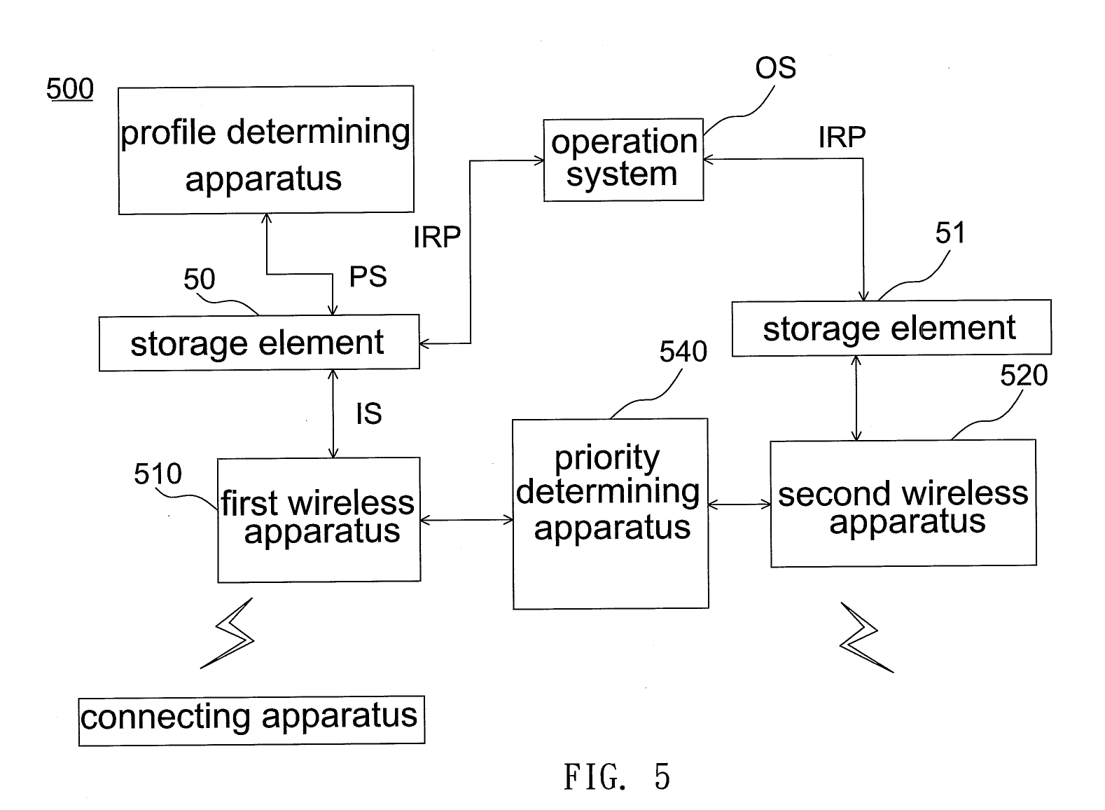

Please refer to FIG. 5, FIG. 5 shows a schematic diagram illustrating a wireless communication system 500 according to one embodiment of the invention. The difference between wireless communication system 100 and 500 is that wireless communication system 500 comprises an operation system OS. Wherein, when profile changes, communication protocol of storage element 50 transfers interrupt request packet (IRP) to storage element 51 through operation system OS, and make second wireless apparatus 520 defer to transfer packet. Moreover, second wireless apparatus 520 adjusts transmission by changing profiles and determining from priority determining apparatus 540. Wherein, storage element 51 is to store a driver to operate second wireless apparatus 520.

In other words, first wireless apparatus 510 transfer profile information by communication protocol of upper storage element 50 and storage element 51 of WI-FI terminal. As shown in FIG. 5, when the profile utilized by first wireless apparatus 510 changes, communication protocol of storage element 50 transfers IRP via operation system OS to inform storage element 5 lof WI-FI terminal. After storage element 51 receives profile information, storage element 51 selects corresponding coexistence mechanism according to different attributes of profiles.

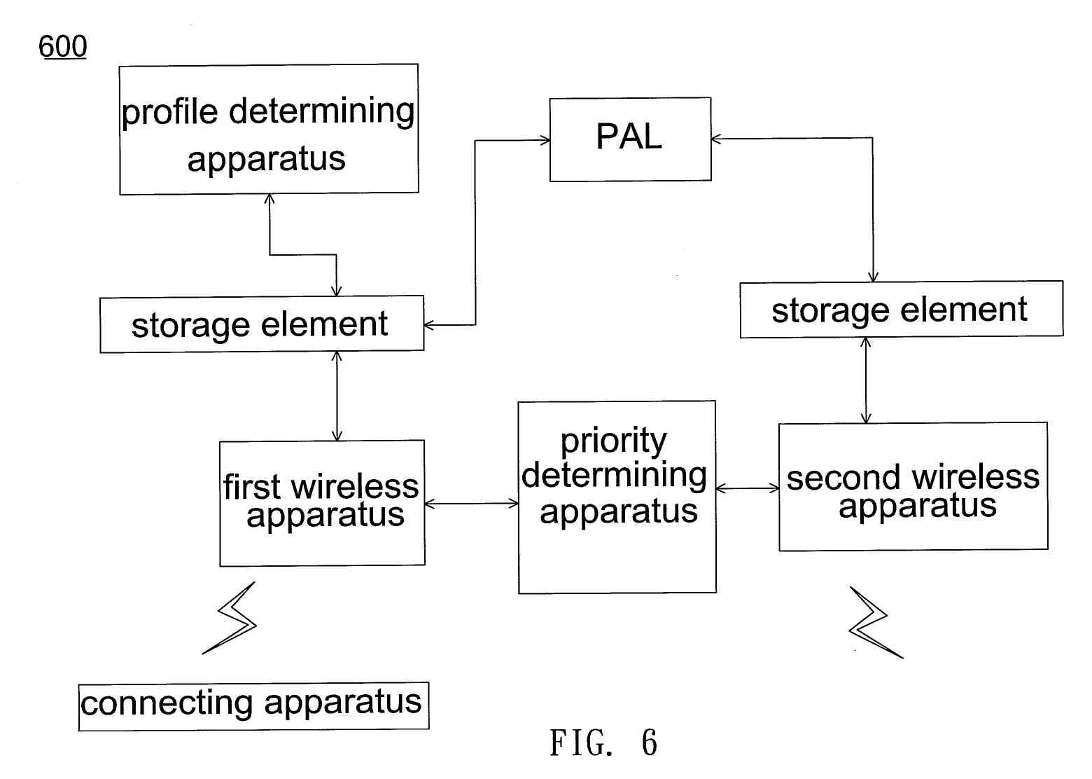

Please refer to FIG. 6, FIG. 6 shows a schematic diagram illustrating a wireless communication system 600 according to one embodiment of the invention. The difference between wireless communication system 600 and 500 is that wireless communication system 600 utilizes physical layer (PHY) of WI-FI terminal to increase data transmission speed. In order to control lower layer by upper layer driver, wireless communication system 600 defines a protocol adaptation layer (PAL) to convert control interface signal IS into corresponding signal of WI-FI terminal. Therefore, the information of Bluetooth profile can be transferred by PAL.

However, when the profile utilized by Bluetooth changes, communication protocol utilizes control interface signal IS via PAL to inform driver of WI-FI, communication protocol selects corresponding coexistence mechanism according to different attributes of profiles.

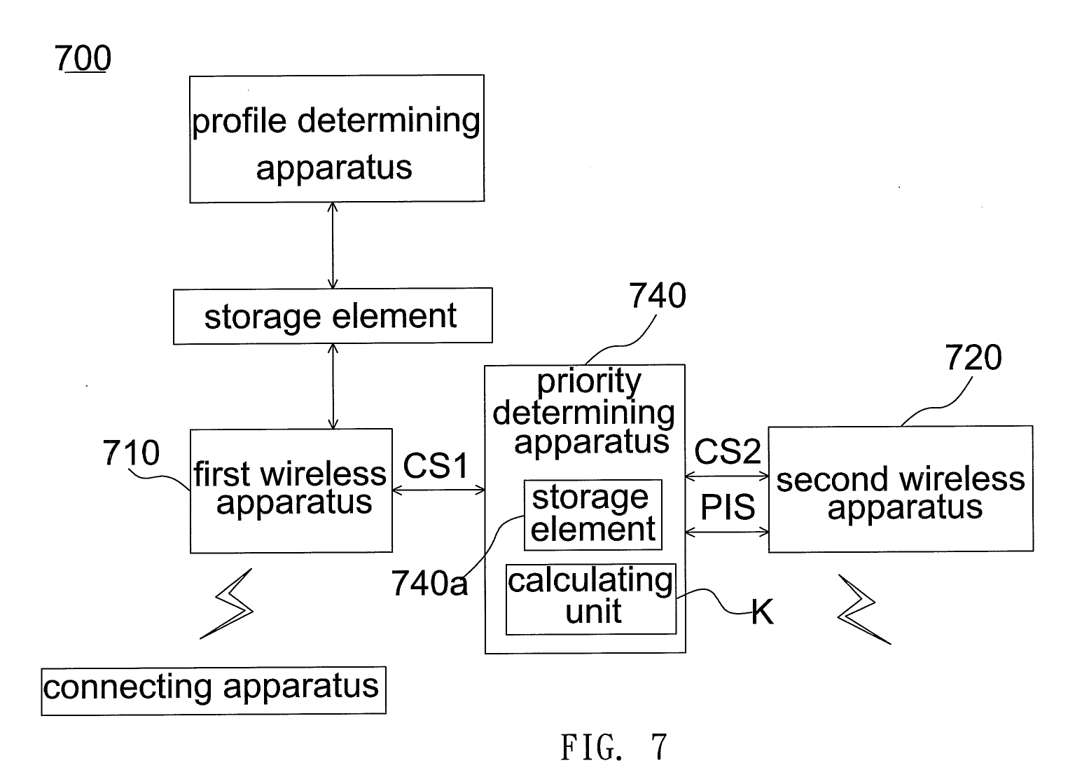

Please refer to FIG. 7, FIG. 7 shows a schematic diagram illustrating wireless communication system 700 according to one embodiment of the invention. The difference between wireless communication system 100 and 700 is that priority determining apparatus 740 includes a calculating unit K which is to calculate the amount of plural packet types during a preset time, and determine profile of first wireless apparatus 710.

In other words, when first wireless apparatus 710 can not transfer profile information to second wireless apparatus 720 (WI-FI) via coexistence signal CS1 and CS2, or the upper layer protocol of first wireless apparatus 710 and the upper layer protocol of wireless apparatus 720 can not transfer signal to each other, priority determining apparatus 740 determines present profile types according to the method of utilizing calculating unit K to calculate packet form of first wireless apparatus 710.

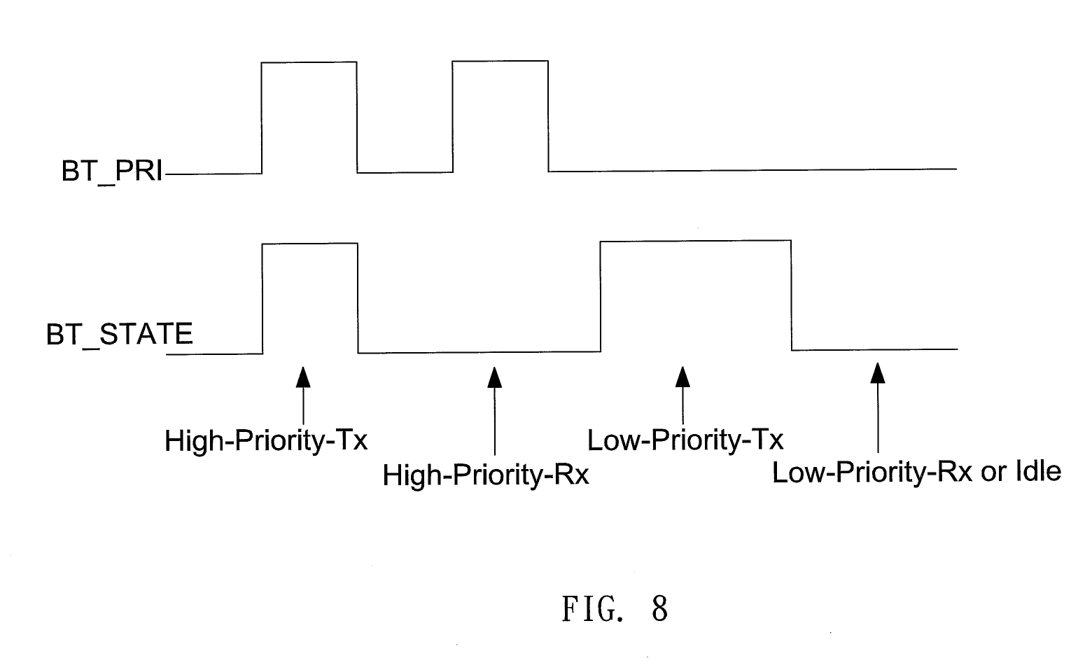

Please also refer to FIG. 8, FIG. 8 shows a schematic diagram illustrating coexistence signal according to one embodiment. As shown in FIG. 8, in general, coexistence signal CS1 transmitted from first wireless apparatus 710 (in the embodiment is Bluetooth) to second wireless apparatus 720 (in the embodiment is WI-FI) includes signals BT_PRI and BT_STATE. BT_PRI is to indicate that whether first wireless apparatus 710 has high priority or not; BT_STATE is to indicate that whether first wireless apparatus 710 is in transferring mode or receiving mode.

Priority determining apparatus 740 can determine that Bluetooth is in transferring (Tx) or receiving (Rx) according to combined signals BT_PRI and BT_STATE. When both logic values of BT_PRI and BT_STATE are 1, priority determining apparatus 740 determines that first wireless apparatus 710 is High-Priority-Tx; when logic value of BT_PRI is 1 and logic value of BT_STATE is 0, priority determining apparatus 740 determines that first wireless apparatus 710 is High-Priority-Rx. Similarly, when logic value of BT_PRI is 0 and logic value of BT_STATE is 1, priority determining apparatus 740 determines that first wireless apparatus 710 is Low-Priority-Tx; when both logic values of BT_PRI and BT_STATE are 0, priority determining apparatus 740 determines that first wireless apparatus 710 is Low-Priority-Rx or Idle.

By utilizing four types of High-Priority-Tx, High-Priority-Rx, Low-Priority-Tx, and Low-Priority-Rx or Idle packets, when first wireless apparatus 710 is utilizing another profile, first wireless apparatus 710 will transfer different types and numbers of packets in a predetermined time period. Ex: when first wireless apparatus 710 is communicating with a Bluetooth headphone, the profile is Handset Free profile. However, because voice communication has high priority, it is observed that a couple of high priority packets, High-Priority-tx and High-Priority-Rx, are presented in the coexistence signal CS1 in every predetermined time period.

When first wireless apparatus 710 is communicating with a Bluetooth headphone and listening High-fidelity music, AD2P will be transferred by utilizing with Low-Priority-tx and Low-Priority-Rx, because music transmission can be retransmitted and pre-buffer. Then, the packet densities of High-Priority-tx and High-Priority-Rx will not higher than Handset Free profile.

Therefore, wireless communication system 700 transfers coexistence signal CS1 of first wireless apparatus 710 (Bluetooth) to priority determining apparatus 740 to determine packet according to packet-by-packet base, besides priority determining apparatus 740 proceeds coexistence signal CS1 for packet identification and classification by utilizing calculating unit K.

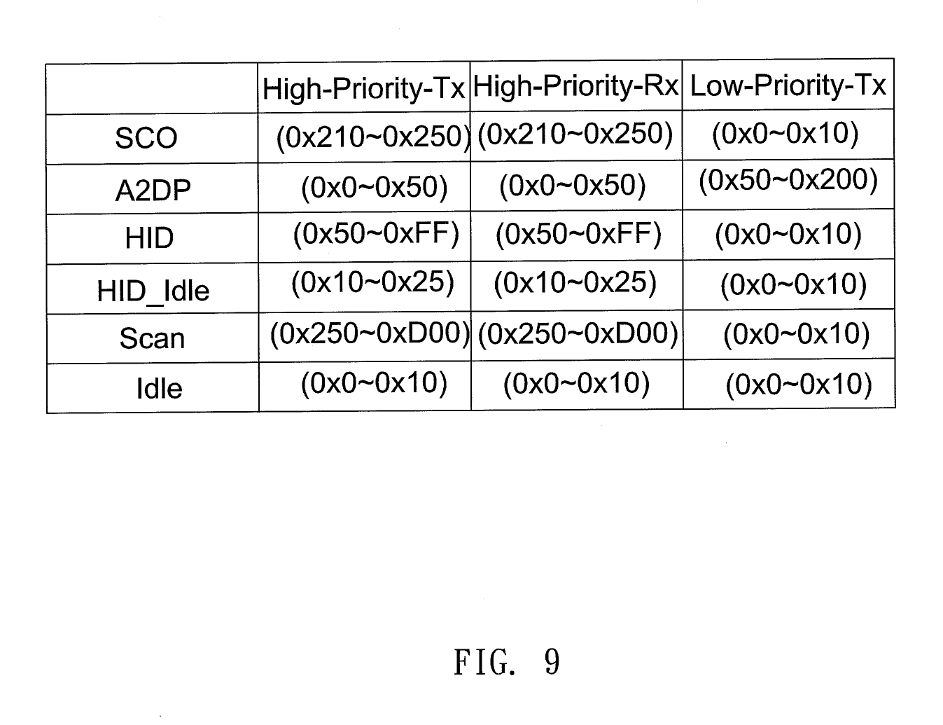

It should be noted that, determining apparatus 740 includes a storage element 740a which stores a look-up table; calculating unit K compares the number of packets with the look-up table, so that determining apparatus 740 can determine the profile of first wireless apparatus 710. Please also refer to FIG. 9, FIG. 9 shows a look-up table illustrating wireless communication system 700 according to one embodiment of the invention. Wherein, 0x210˜0x250 in the first field is number of packet presented by hex, and its decimal is 528˜592.

Moreover, SCO means that first wireless apparatus 710 is in progress of Synchronous Connection Oriented (SCO); A2DP means that first wireless apparatus 710 is in progress of Advanced Audio Distribution Profile; HID means that first wireless apparatus 710 is in progress of Human Interface Device Profile (HID); HID_Idle means that first wireless apparatus 710 is in progress of Human Interface Device Idle; SCAN means that first wireless apparatus 710 is in progress of device scanning; Idle means that first wireless apparatus 710 is interrupting connection.

For example, if calculating unit K calculates number of High-Priority-tx is 550 times, High-Priority-rx is 535 times, and Low-Priority-tx is 12 times, it means that first wireless apparatus 710 is in progress of Synchronous Connection Oriented.

Therefore, calculating unit K calculates the number of four different packets, calculating unit K compare the number with the pre-stored look-up-table to determine the profile which is utilizing by first wireless apparatus 710, then calculating unit K will transmit the result to priority determining apparatus 740 and firmware or driver of second wireless apparatus 720 to select corresponding coexistence mechanism according to different profiles.

Wherein, type of look-up-table should not be limited in the present invention, the look-up-table can be implemented by any current, or future, or user required look-up-table.

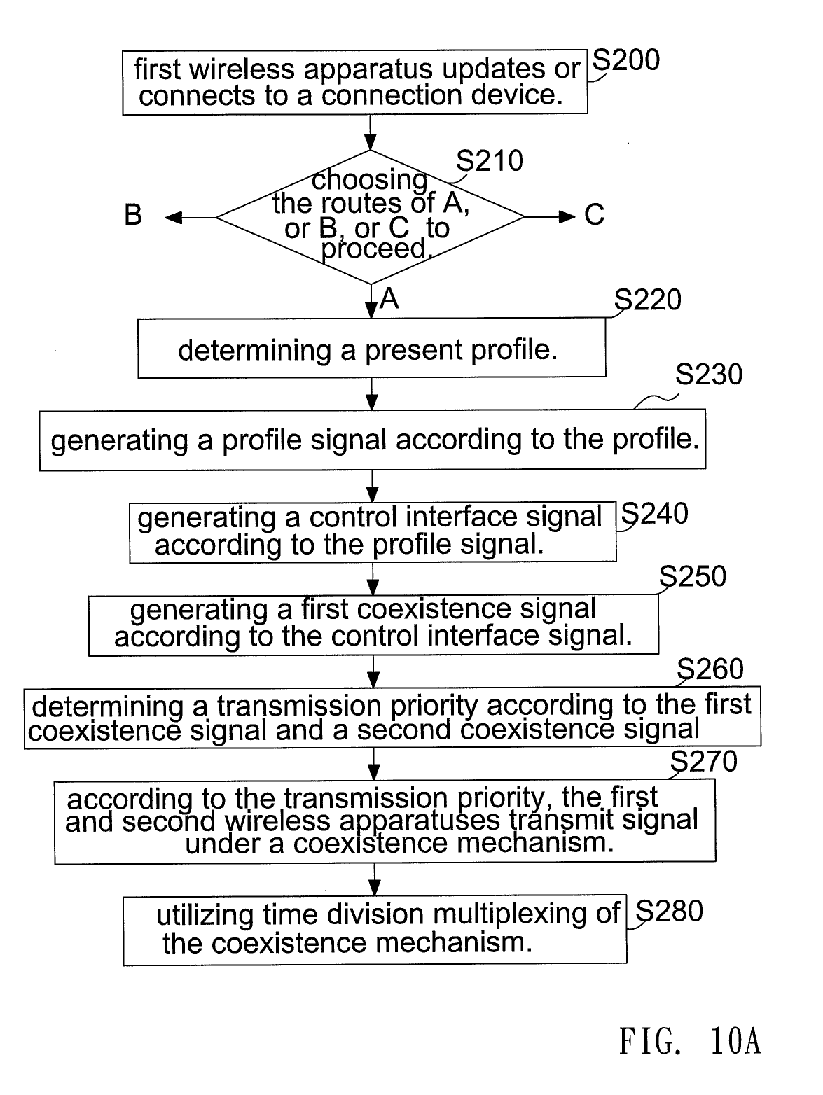

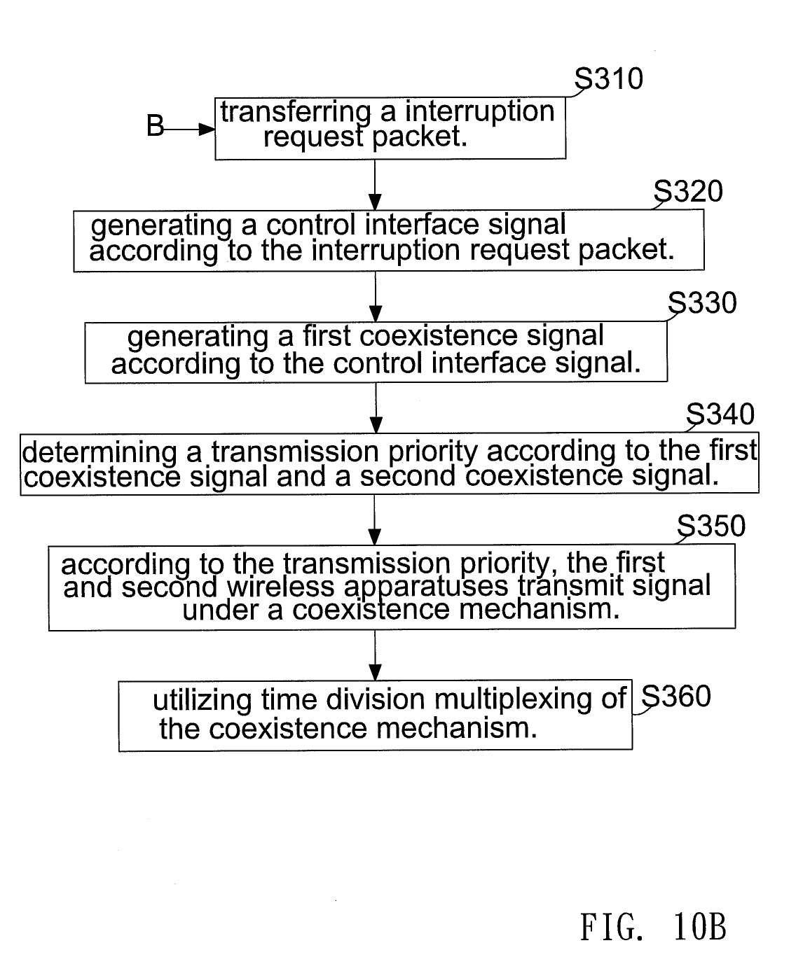

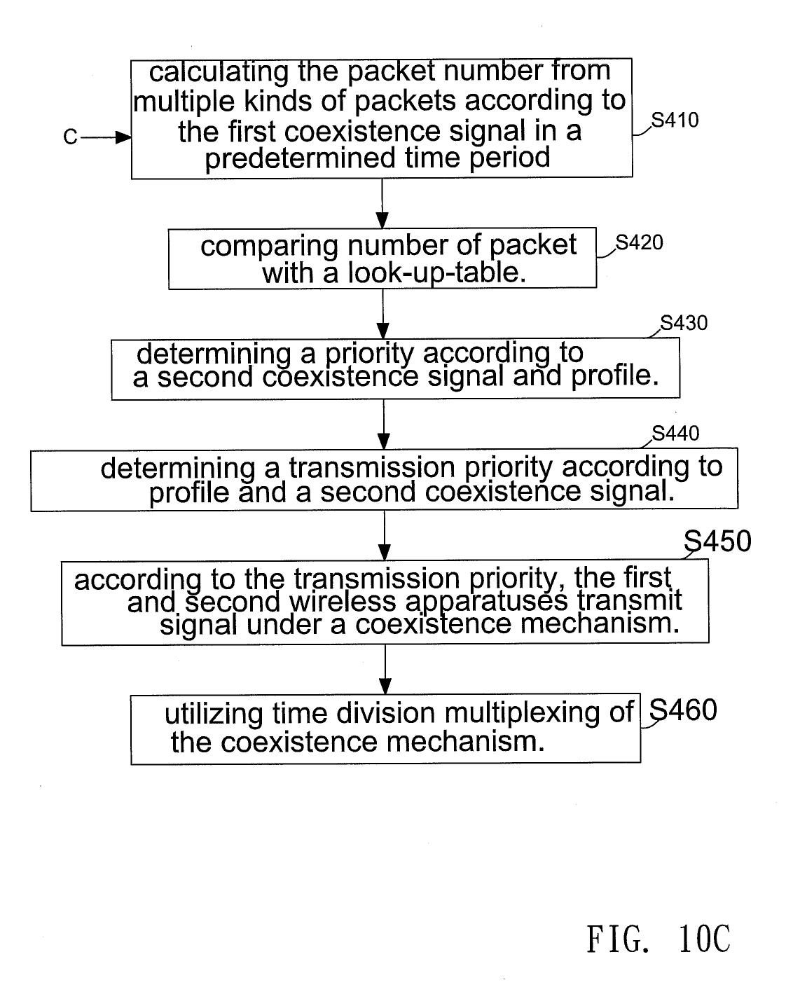

Please refer to FIGS. 10A, 10B, and 10C, FIGS. 10A, 10B, and 10C show a flow chart illustrating an operating example of the method, which uses a plurality of wireless apparatuses simultaneously. The flow chart includes the following steps:

Step S200: first wireless apparatus updates or connects to a connection device, ex: Bluetooth headphone which is used for communicating.

Step S210: choosing the routes of A, or B, or C to proceed.

By route A, step S220: determining a present profile.

Step S230: generating a profile signal according to the profile.

Step S240: generating a control interface signal according to the profile signal.

Step S250: generating a first coexistence signal according to the control interface signal.

Step S260: determining a transmission priority according to the first coexistence signal and a second coexistence signal.

Step S270: according to the transmission priority, the first wireless apparatus and the second wireless apparatus transmit signal under a coexistence mechanism.

Step S280: utilizing time division multiplexing of the coexistence mechanism.

Or by route B, step S310: transferring a interruption request packet.

Step S320: generating a control interface signal according to the interruption request packet.

Step S330: generating a first coexistence signal according to the control interface signal.

Step S340: determining a transmission priority according to the first coexistence signal and a second coexistence signal.

Step S350: According to the transmission priority, the first wireless apparatus and the second wireless apparatus transmit signal under a coexistence mechanism.

Step S360: utilizing time division multiplexing of the coexistence mechanism.

Or by route C, step S410: calculating the packet number from multiple kinds of packets according to the first coexistence signal in a predetermined time period.

Step S420: comparing number of packet with a look-up-table.

Step S430: determining profile of the first wireless apparatus according to the comparison result.

Step S440: determining a transmission priority according to a second coexistence signal and profile.

Step S450: According to the transmission priority, the first wireless apparatus and the second wireless apparatus transmit signal under a coexistence mechanism.

Step S460: utilizing time division multiplexing of the coexistence mechanism.

In sum, wireless communication system of the present invention sets a priority determining apparatus, that is to determine transmission priority by the profile in coexistence system of multiple wireless apparatuses. Therefore, transmission efficiency in coexistence system will be optimized and solve the problem of prior art.

What is claimed is:

1. A wireless communication system, comprising:
a first wireless apparatus for transferring a first signal;
a second wireless apparatus for transferring a second signal; and
a priority determining apparatus for determining a transmission priority of the first wireless apparatus and the second wireless apparatus under a coexistence mechanism according to a profile of the first wireless apparatus;
wherein the first wireless apparatus and the second wireless apparatus conform to different communication standards.

2. The system according to claim 1, wherein the coexistence mechanism is a time-division mechanism, the first wireless apparatus is a Bluetooth apparatus and the second wireless apparatus is a WLAN apparatus.

3. The system according to claim 1, wherein the profile is determined according to an apparatus which the first wireless apparatus is connected to.

4. The system according to claim 1, wherein a packet density of the first signal or the second signal is adjusted by the transmission priority.

5. The system according to claim 1, wherein the wireless communication system comprises a first storage element to store a communication protocol; the storage element receives a profile signal to generate a control interface signal to the first wireless apparatus.

6. The system according to claim 5, wherein the control interface signal utilizes a standard op code group field of a host controller interface command of Bluetooth to transfer the profile signal to the first wireless apparatus.

7. The system according to claim 1, wherein the wireless communication system comprises a second storage element to store a communication protocol; when the profile is changed, the first storage element transmits a interruption request packet to defer the transmission of the second wireless apparatus.

8. The system according to claim 1, wherein the first wireless apparatus transmits a first coexistence signal to the priority determining apparatus; the priority determining apparatus comprises a calculating unit for determining the profile by calculating a packet number from multiple kinds of packets according to the first coexistence signal in a predetermined time period.

9. The system according to claim 8, wherein the priority determining apparatus comprises a third storage element; the third storage element stores a look-up table; the calculating unit determines the profile by comparing the packet number and the look-up table.

10. A sharing method of a first wireless apparatus and a second wireless apparatus, the first wireless apparatus is to transfer a first signal, the second wireless apparatus is to transfer a second signal, the first and the second wireless apparatuses conform to different communication standards, the method comprises:
determining a transmission priority of the first wireless apparatus and the second wireless apparatus under a coexistence mechanism according to a profile of the first wireless apparatus.

11. The method according to claim 10, wherein the coexistence mechanism is a time-division mechanism that the first wireless apparatus and the second wireless apparatus transmit the first signal and second signal accordingly.

12. The method according to claim 10, wherein the step of determining the priority according to the profile comprises:
determining the profile according to an apparatus which the first wireless apparatus is connected to.

13. The method according to claim 10, wherein a packet density of the first signal or the second signal is adjusted by the priority.

14. The method according to claim 10, further comprises:
storing a communication protocol;
receiving a profile signal; and
generating a control interface signal to the first wireless apparatus.

15. The method according to claim 14, wherein the control interface signal utilizes a standard op code group field of a host controller interface command of Bluetooth to transfer the profile signal to the first wireless apparatus.

16. The method according to claim 10, wherein the steps of determining the priority according to the profile comprise:
generating a profile signal according to the profile;
generating a control interface signal according to the profile; and
adjusting the priority according to the control interface signal.

17. The method according to claim 10, comprises:
transferring a interruption request packet to defer the transmission of the second wireless apparatus when the profile is changed.

18. The method according to claim 10, comprises:
transferring a first coexistence signal; and
calculating a packet number from multiple kinds of packets according to the first coexistence signal in a predetermined time period.

19. The method according to claim 18, wherein the step of calculating the packet number from multiple kinds of packets according to the first coexistence signal in the predetermined time period comprises:
determining the profile by comparing the packet number with a look-up table.
